(19) United States
(12) Patent Application Publication
(10) Pub. No.: US 2017/0185394 A1
(43) Pub. Date: Jun. 29, 2017

(54) METHOD AND SYSTEM FOR CUSTOMIZING SOFTWARE

(71) Applicant: SAP SE, Walldorf (DE)

(72) Inventors: Lars Erbe, Stutensee (DE); Stefan Haffner, Hockenheim (DE); Markus Viol, Walldorf (DE); Alexander Rauh, Weinheim (DE); Carsten Brandt, Mannheim (DE); Felix Riegger, Mannheim (DE); Christian Voshage, Eppelheim (DE); Axel Wamer, Maxdorf (DE)

(21) Appl. No.: 14/757,976

(22) Filed: Dec. 23, 2015

(51) Int. Cl. G06F 9/44; G06F 9/455

(52) U.S. Cl. CPC G06F 8/71; G06F 9/45525; G06F 8/38

(57) ABSTRACT

A system facilitates modification or adaptation of a software object or platform, developed by a software developer, by a plurality of entities, each entity is assigned a hierarchical level, the lowest hierarchical level being assigned to a software developer and the highest hierarchical level being assigned to an end-user. At each level, when a modification or adaptation is implemented, a separate layer file or layer of a layer file is created and stored in a database. Subsequently, the changes of the respective layers are implemented in sequence according to the hierarchy, so that a higher hierarchical level's modifications that are in conflict with a setting of a lower hierarchical level replace the implementation of the lower hierarchical level's setting during runtime.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### BACKGROUND

Software developers design multi-purpose software objects and platforms so that various partners, administrators, and end-users can customize and adapt the software for their needs. Such software objects or platforms can be provided to users on a cloud space or on on-premises servers.

### BRIEF DESCRIPTION OF THE DRAWINGS

FIG. 1A illustrates an example cloud space according to an example embodiment.

FIG. 1B illustrates an example on-premises server according to an example embodiment.

FIG. 2 is an example embodiment of a final layer file according to an example embodiment.

FIG. 3 illustrates an example embodiment of a layer file.

### DETAILED DESCRIPTION

In a small setting, where a software developer or vendor provides a software product directly to end-users, end-users can directly customize the software provided to them by adding a layer on top of the original source code. A layer is a repository which includes deltas. When a layer is merged with the source code, the software can include all of the customizations intended for the software. The layer can be stored as a separate file without modifying the original source code, but, during runtime, the content of the layer can be merged with the source code and results in a different source code and ultimately different software.

For example, a software developer or vendor can provide an end-user with an email service which is run on a cloud space, operated by the software developer. The end-user can be given the option to select a mailbox theme for the end-user's mailbox. With a layering technology, the end-user can select the mailbox theme by storing a layer file including the end-user's selection of the mailbox theme.

By using a layer, a user can systematically store and track the modifications added or adaptations made. When a software developer provides updates or upgrades for a software, the changes can come in two forms. If the end-user is utilizing the software object or platform on a cloud space, the updates or upgrades can be implemented directly on the cloud. In on-premises server scenarios, the updates or upgrades generally come via patches directly sent to the host of the server. Once the updates or upgrades are implemented on the underlying software object or platform, the layer can be added on top of the updated or upgraded software object or platform and provide the same user modifications or adaptations that the user implemented before. As a result, when the software developer provides upgrades or updates for the software, the user can still maintain the user's modifications or adaptations.

Similarly, in the context of changing a software product developed of a first developer with another software product developed by a second developer, using a layering technology can be helpful. Specifically, many software platforms provide for compatibility of settings between various platforms. By using a layer, the user can maintain the user's previously selected modifications or adaptations, and carry them over into the new platform. The new software platform can read and implement the user stored modifications or adaptations.

Some software developers design multi-purpose and adaptable software objects and platforms capable of functionality and operation in various geographical regions, by numerous industry segments or users with diverse computing needs. At the same time, many of such software developers collaborate with various partners to add a number of add-ons and customized features to adapt or modify the software object or platform so that the software object or platform specifically provides for the needs of the particular customer the partner is targeting.

For example, a software developer can design an operating system including various software functionalities specifically demanded by law firms. Such software functionalities can be word processing and document storage/retrieval capabilities. The operating system can be offered on a cloud space and by a partner of the developer to law firms in various countries. However, the platform needs adaptation to particular needs of the law firms, e.g., a word processing add-on might be required to be added to the platform. Moreover, there can be a need for the software platform to be adapted to particular needs for respective countries. For example, in some countries a disclaimer notice must be displayed every time the system is accessed. The partner can add the word processing add-ons and include the disclaimer notice with the platform, when the partner provides the platform to customer law firms of the respective country.

Furthermore, each entity, including one or more end-users who use the software object or platform, may demand entity specific modifications or adaptations. Such modifications or adaptations can be implemented by an administrator of the software. The administrator, who is a user associated with the organization, can be given the authority to make the entity specific modifications or adaptations. For example, the administrator can modify the background screen of the software to include the trademark of a law firm for which the system is being provided. Lastly, each end-user may wish to implement end-user specific modifications or adaptations. For example, an end-user may increase the default volume for the software platform so that each time the software platform is accessed the modified default volume is implemented. On the other hand, another user may want to set the volume on mute all the time.

For a multi-purpose software to be fully adapted and utilized by all end-users, there can be various levels of modification or adaptation by various parties, which sometimes implement the adaptations or modifications in sequential layers. It is possible to implement these modifications or adaptations directly in the source code of the original software object or platform. However, direct implementation can result in several disadvantages. Specifically, direct implementation of these modifications or adaptations would result in direct access to the source code by various external parties, a scenario with which the software developer may not be comfortable. Moreover, this would result in a plurality of versions of the same source code being maintained even in the cloud scenario, even though core functionality is the same across the various versions. Lastly, in case the software developer or vendor needs to implement modifications or add updates to the source code, the software developer or vendor will have to implement the modifications or updates in every source code version, which can be resource intensive and time consuming as each version of the source code is individually adapted or modified.

Usage of layering technology on multiple levels can provide significant benefits in resolving the disadvantages associated with the direct implementation. According to an example embodiment, a plurality of entities can each modify or adapt a software object or platform developed by a software developer. Each entity is assigned a hierarchy level, with the lowest hierarchical level being assigned to the software developer and the highest hierarchical level being assigned to an end-user. At each level, when a modification or adaptation is implemented, a separate layer file is created and stored in a database which includes the software, so that the database can include multiple layer files corresponding to modifications or adaptations by respective ones of the entities. In an example embodiment, the files are merged into a single final layer file. Regardless of whether stored as a single file or multiple files, the changes are recorded in the one or more files according to the sequential hierarchical levels for sequential layered implementation during runtime. If there are any discrepancies between settings according set by the modifications or adaptations of two different layers, the discrepancy is resolved in favor of the modification or adaptation requested by the entity assigned to the higher hierarchical level, i.e., the level closest to the end-user experience, unless the setting violates a rule, e.g., set at a lower hierarchical level, e.g., where the end-user setting violates an administrator rule.

In another example embodiment, the single layer file is initially operated upon at each hierarchical level, to store the respective hierarchical layers in the single file. Specifically, at the first level (i.e., the lowest hierarchical level), the vendor implements the vendor's modifications or adaptations, which can be incorporated into the one layer file. Then, as each entity expresses its modifications or adaptations, the modifications or adaptations are added to the one layer file. Any conflicts or discrepancies with previous changes are resolved during runtime in favor of the modifications or adaptations of the entity at the higher hierarchical level.

Regardless of whether there are multiple layer files combined into one final layer file, or whether there is one layer file to which the modifications or adaptations of all of the parties are added, both a cloud system and an on-premises server are capable of making the combinations.

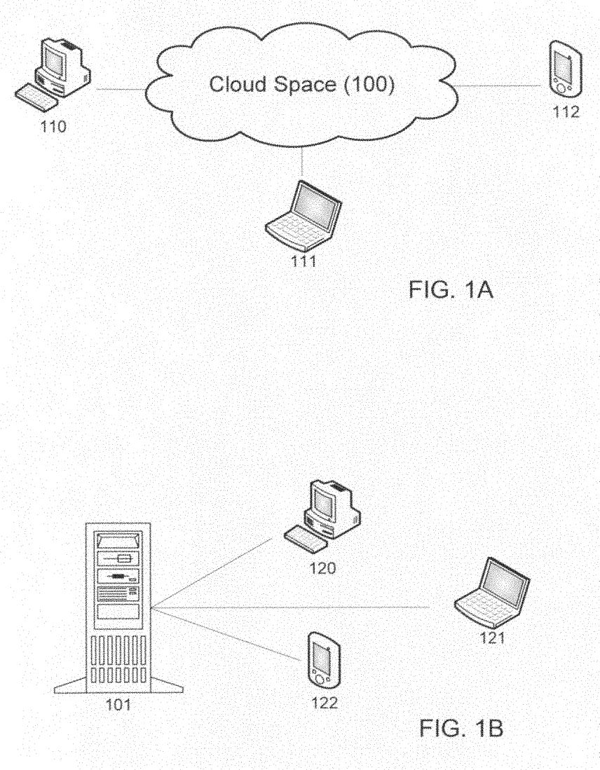

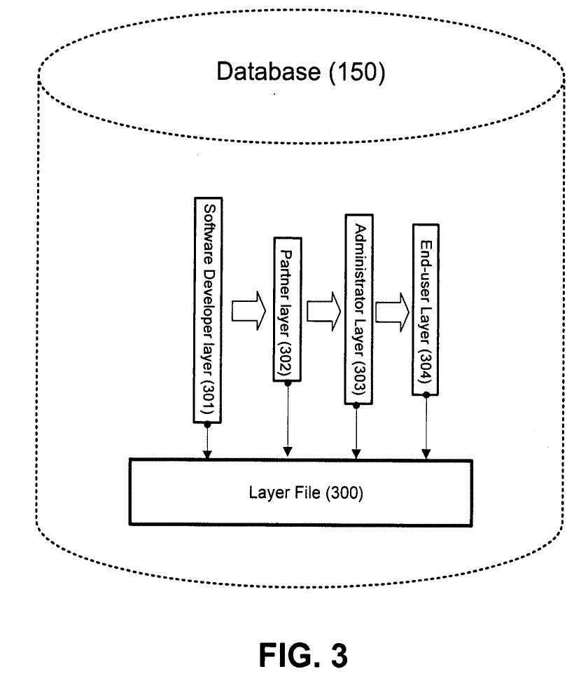

FIG. 1A illustrates an example cloud space 100 according to an example embodiment. Cloud space 100 is connected to various terminals which are able to communicate with and receive information from cloud space 100. The connections can be through a global network such as the internet or any other network. In this example embodiment, the terminals are terminal 110, terminal 111, and terminal 112. Cloud space 100 includes a database 150, illustrated in FIG. 3, which is a repository for software objects or platforms. The system is configured the software objects or platforms to run using processing power provided in the cloud space 100. The system is configured to store at least one layer file in the database 150, e.g., in the cloud space 100. A software developer has access to cloud space 100 and can change its content using one of the terminals.

FIG. 1B illustrates an example on-premises server 101 according to an example embodiment. On-premises server 101 is connected to various terminals which are able to communicate to and receive information from on-premises server 101. The connection can be, for example, through a local network. In this example embodiment, the terminals are terminal 120, terminal 121, and terminal 122. On-premises server 101 includes a database 150, illustrated in FIG. 3, which is a repository for software objects or platforms. On-premises server 101 can run the software objects or platforms using its processing power. On-premises server 101 is configured to store at least one layer file. A software developer, depending on the server's host, may or may not have access to on-premises server 101.

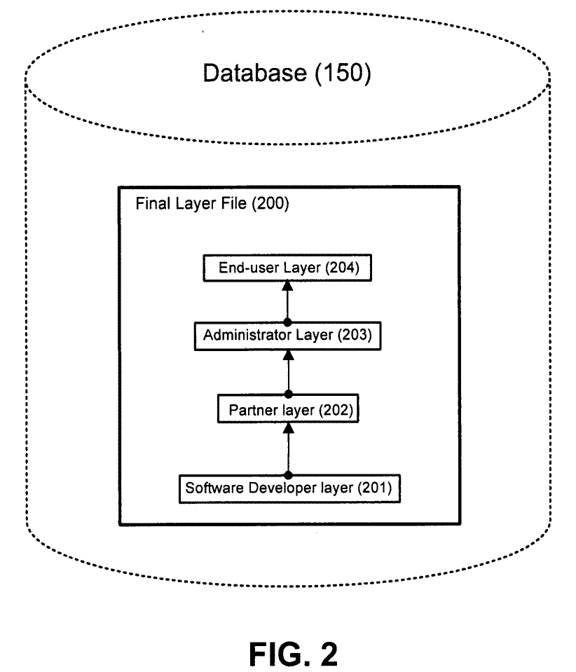

FIG. 2 illustrates an example embodiment of a final layer file according to an example embodiment. In this example embodiment, a software developer designs a software platform configured to include various add-ons relating to accounting. The software developer, after having developed the software platform, can add adaptations or modifications relating to the geographical region in which the software platform is going to be used, e.g., language related adaptations or modifications. These modifications or adaptations can be stored in the software developer layer 201.

The software developer can have a partner, who designs an accounting add-on, to add to the software platform designed by the software developer. The partner also intends to customize or modify various features of the platform. For example, the partner intends to change the color theme of the platform, to a theme that matches the partner's trade dress. The partner can make these changes and the system can store them in the partner layer file 202.

The partner offers the software platform including the accounting add-on to an organization including several end-users. In this example embodiment, the organization can be an accounting firm. The accounting firm has an administrator who has the authority to customize the software platform. For example, the administrator can add a disclaimer message to the platform so that every time the platform is accessed, the disclaimer message is displayed. The modifications or adaptations that the administrator is making are saved in the layer file 203. Lastly, the end-users in the organization can modify or adapt the software platform. For example, an end-user can modify the software platform to include a shortcut to a calculator application on the user interface of the software platform. The end-user's modifications are then stored in the layer file 204.

Once every party's respective modifications or adaptations have been provided, the layer files 201-204 can be combined to create a final layer file 200. In an example embodiment of the cloud scenario, each party stores the respective party's layer file in the cloud space 100, where the final layer file is then generated based on the stored party layer files. In the on-premises scenario, some of the parties do not have direct access to the on-premises server. For example, the software developer and the partner might not have access to the on-premises server. Therefore, each party which does not have direct access to the on-premises server can send the party's layer file separately or together with other parties to the server administrator, e.g., as a patch, for storing on the on-premises server where the layer files can be combined to create the final layer file.

The following is a non-exhaustive and example list of the modifications or adaptations that can be provided by way of the respective layer files: language features; color theme of the platform; a disclaimer message; and the shortcut. Where the modifications or adaptations are not in conflict with each other, the layer files can be combined irrespective of the hierarchical level of the party which created the layer file. The layer file 200 will include all of the modifications or adaptations named by each of layer files 201-204.

FIG. 3 is another example of a layer file. In the example embodiment of the layer file of FIG. 3, during the modification or adaptation of various parties, there is only one layer file to be modified or adapted. Specifically, each party's modification or adaptation is directly incorporated into the layer file. In the example embodiment of FIG. 3, the same modification or adaptations of FIG. 2 can be incorporated into the layer file. Specifically, software developer 301 creates a layer file 300 which includes only the modifications or adaptations of the software developer. Subsequently, partner 302 adds a color theme layer to the platform, which can be directly incorporated into the layer file 300; system administrator 303 adds a disclaimer message layer, which can be directly incorporated into the layer file 300; and end-user 304 adds a shortcut layer, which can be directly incorporated into the layer file 300. In the example embodiment of FIG. 3, the cloud or on-premises server incorporates each party's requested modification or adaptation as a respective layer directly into the layer file 300.

In the on-premises scenario and when there is only one layer file, because all of the parties who request modifications or adaptations do not have access to the on-premises server, a layer file can be created by the software developer and subsequently be passed on to the on-premises server. The layer file can include the modifications or adaptations of the software developer. The layer file can also include the modifications or adaptations of other parties who do not have access to the on-premises server. Subsequently, the layer file is sent to the administrator of the on-premises server, who stores the layer file on the on-premises server. Then, the administrator and the end-users can implement their modifications or adaptations in the layer file.

In an example, a conflict can arise between the modifications or adaptations of layers of two or more of the parties, in which case the system resolves the conflict according to the respective hierarchical levels of the layers, in favor of the highest hierarchical level, i.e., closest to the end-user (unless there is no authority given to the party who has entered the modification to do so), by a sequential implementation of the changes. For example, the partner selects a color theme for the platform; the administrator changes the color theme to a theme that matches the accounting firm's trade dress; and the end-user deactivates the color theme in its entirety. In this example, the partner is assigned to hierarchical level 2, the administrator is assigned to hierarchical level 3, and the end-user is assigned to hierarchical level 4. The system incorporates each party's requested modifications or adaptations into a layer file (or a final layer file, if there are multiple layer files). The conflicts are then resolved during runtime by sequentially applying the settings of each layer, so that the end-user's selection is ultimately provided.

As noted above, there can be certain restrictions set at the lower hierarchical levels that restrict settings that can be set at the higher hierarchical levels. For example, an administrator can be assigned priority level greater than the end-user according to which the administrator can block certain end-user settings from being implemented. For example, if the administrator sets that the color theme of the software platform cannot be altered from the company's trade dress, the end-user would not be able to change the feature. However, the end-user can still add or delete a shortcut if it does not conflict with the administrator's requirements.

In another example embodiment, the features which can be modified or adapted by the parties are assigned to several classes and each class is assigned a priority level order. Therefore, each party can be assigned a priority level for a given class of features, which can be different from the priority level of another class of features. Thus, while a given party can overrule another given party when it comes to a class of features, the given party can be subordinate to the other given parties when it comes to another class of features.

For example, the features can be assigned to two classes, user-modifiable features and non-modifiable features. A color theme of the software platform can be a feature which the accounting firm intends to keep uniform for all of the end-users, and thus is assigned to the class of non-modifiable features. On the other hand, customization of the shortcuts by end-users can be encouraged by the firm, and hence, customization of shortcuts is assigned to the class of user-modifiable features. The priority level for administrator can be higher than the end-users for the non-modifiable class of features, but the priority level of the end-users can be higher than the administrator for the user-modifiable class of features. Hence, the administrator makes the final determination regarding the color theme of the software platform, and the administrator's adaptations or modifications are implemented in the layer file (or the final layer file, if there are multiple layer files), and the user's attempted change to the setting is blocked from being added to a layer of the layer file. Nonetheless, the end-users can still decide their own shortcuts, even if they are conflicting with the administrator's request, to add that setting as an additional layer to the layer file (or the final layer file, if there are multiple layer files).

An example embodiment of the present disclosure is directed to one or more processors, which can be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors can be embodied in a server or user terminal or combination thereof. The user terminal can be embodied, for example, as a desktop, laptop, hand-held device, Personal Digital Assistant (PDA), television set-top Internet appliance, mobile telephone, smart phone, smart watch, etc., or as a combination of one or more thereof. The memory device can include any conventional permanent and/or temporary memory or data-recording circuits or mediums, or combination thereof, a non-exhaustive list of which includes Random Access Memory (RAM), Read Only Memory (ROM), Compact Disks (CD), Digital Versatile Disk (DVD), and magnetic tape.

An example embodiment of the present disclosure is directed to one or more hardware computer-readable media, e.g., as described above, having stored thereon instructions executable by a processor to perform the methods described herein.

An example embodiment of the present disclosure is directed to a method, e.g., of a hardware component or machine, of transmitting instructions executable by a processor to perform the methods described herein.

The above description is intended to be illustrative, and not restrictive, and although the above description provides details for purposes of clarity of understanding, it will be apparent that certain changes and modifications may be practiced within the scope of the following claims. The invention is not to be limited to the details given herein, but may be modified within the scope and equivalents of the following claims. For example, those skilled in the art can appreciate from the foregoing description that the present disclosure may be implemented in a variety of forms, and that the various embodiments may be implemented alone or in combination. Therefore, while the embodiments of the present disclosure have been described in connection with particular examples thereof, the true scope of the embodiments and/or methods of the present disclosure should not be so limited since other modifications will become apparent to the skilled practitioner upon a study of the drawings, specification, and following claims. For example, the present disclosure may be practiced according to the claims without some or all of these specific details. For the purpose of clarity, technical material that is known in the technical fields related to the invention has not been described in detail so that the present disclosure is not unnecessarily obscured.

What is claimed is:

1. A method for providing customized instantiations of a software object, the method comprising:
for a plurality of sets of software implementation customization settings provided via one or more terminals and in association with respective ones of a plurality of user profiles, storing, in a data storage device, a plurality of customization layers corresponding to the respective user profiles, each of the customization layers including the respective set of software implementation customization settings received in association with the respective user profile; and
executing, by the processing circuitry and during runtime, the software object, wherein the execution includes sequentially implementing each of the layers in an order that is in accordance with a relationship between the respective user profiles to which the respective layers correspond.

2. The method of claim 1, further comprising:
assigning a priority level to each of the plurality of user profiles, which determines whether a higher hierarchical level layer can include a setting that conflicts with a setting of a lower hierarchical level for a particular feature or class of features.

3. The method of claim 2, wherein different priority levels are assigned to different ones of the user profiles for different classes of features, so that a first profile is assigned a higher priority than a second profile for a first one of the classes and the second profile is assigned a higher priority than the first profile for a second one of the classes.

4. The method of claim 1, wherein each of the layers is provided as a separate respective layer file, and the method further comprises combining the separate layer files into a final layer file, which is used during the runtime.

5. The method of claim 1, wherein the order is from a lowest hierarchical level layer associated with a user profile categorized as furthest to end user output to a highest hierarchical level layer associated with a user profile categorized as closest to end user output, such that, if there is a discrepancy between a setting in different ones of the layers, the setting of the higher hierarchical level layer is provided as output due to execution of the later execution of the higher hierarchical level layer subsequent to and therefore as a replacement of the earlier execution of the lower hierarchical level layer.

6. The method of claim 1, wherein each of the layers is provided by direct operation on a layer file to add the respective layers to the layer file.

7. A non-transitory computer-readable data storage medium storing a computer program code which, when executed on a computer, implement a method for providing customized instantiations of a software object, the method comprising:
for a plurality of sets of software implementation customization settings provided via one or more terminals and in association with respective ones of a plurality of user profiles, storing, in a data storage device, a plurality of customization layers corresponding to the respective user profiles, each of the customization layers including the respective set of software implementation customization settings received in association with the respective user profile; and
executing, by the processing circuitry and during runtime, the software object, wherein the execution includes sequentially implementing each of the layers in an order that is in accordance with a relationship between the respective user profiles to which the respective layers correspond.
